(19) United States
(12) Patent Application Publication
(10) Pub. No.: US 2025/0137478 A1
(43) Pub. Date: May 1, 2025

(54) FIXING DEVICE FOR STEPLESS BUFFER UNLOCKING

(71) Applicant: HANWIT PRECISION INDUSTRIES LTD., New Taipei City (TW)

(72) Inventors: Ying-Chih TSENG, New Taipei City (TW); Ming-De WU, New Taipei City (TW)

(21) Appl. No.: 19/006,973

(22) Filed: Dec. 31, 2024

Related U.S. Application Data
(63) Continuation-in-part of application No. 17/722,813, filed on Apr. 18, 2022.
Application No. 17/722,813 is a continuation-in-part of application No. 17/510,777, filed on Oct. 26, 2021, now Pat. No. 12,234,849.
(63) Continuation-in-part of application No. 17/510,777, filed on Oct. 26, 2021, now Pat. No. 12,234,849.

(30) Foreign Application Priority Data
Oct. 8, 2021 (TW) 110137594

(51) Int. Cl. F16B 5/06

(52) U.S. Cl. CPC F16B 5/0621

(57) ABSTRACT

A fixing device includes a base provided with a base body, a receiving chamber, a through hole and a block, a slide including a substrate, a gradient groove located on the substrate with a relatively narrower locking side formed at one end and a relatively wider unlocking side formed at an opposite end, an abutment block protruding downward from one side of the substrate, a stop surface formed on an opposite side of the substrate for contacting the block at an inclined angle and an elastic member supported between the abutment block and the base, and a support including a positioning plate fixed in a plate holder of a preset machine box, a positioning rod extending from the positioning plate into the through hole of the base and the gradient groove of the slide and an annular stop surface formed between the positioning plate and the positioning rod.

### CROSS REFERENCE TO THE RELATED APPLICATIONS

This application is a Continuation-In-Part of application Ser. No. 17/722,813, filed on Apr. 18, 2022; which is a Continuation-In-Part of application Ser. No. 17/510,777, filed on Oct. 26, 2021; this application is also a Continuation-In-Part of application Ser. No. 17/510,777, filed on Oct. 26, 2021; for which priority is claimed under 35 U.S.C. § 120, the entire contents of all of which are hereby incorporated by reference.

This application claims the priority benefit of Taiwan patent application number 110137594, filed on Oct. 8, 2021.

### BACKGROUND OF THE INVENTION

### 1. Field of the Invention

The present invention relates to a fixing device for stepless buffer unlocking, particularly a fixing device that forms a fully unlocked state when the positioning rod located on the unlocking side of the gradient groove and the elastic member is in a compressed state and the stop surface of the slide contacts the block of the base; when the support moves upward and the annular stop surface pushes the slide to rotate upward with the abutment block as a fulcrum, the stop surface of the slide separates from the block of the base and changes from a tilted state to a horizontal state; when the elastic member in the extended state pushes the slide and makes the positioning rod contact with the unlocking side and the locking side of the gradient groove, a semi-unlocked state with interference resistance is formed; when the elastic member in the extended state pushes the slide and makes the positioning rod is inserted into the locking side of the gradient groove, a fully locked state is formed.

### 2. Description of the Related Art

The rapid development of the electronics industry has doubled the computing performance of computers and servers. In addition to the main components of the computer, including the motherboard, central processing unit, memory and storage device, the motherboard is also equipped with a variety of connectors with different interfaces to provide expansion of various peripheral devices. To expand various peripheral devices, an interface card is installed with multiple electronic components and corresponding circuit layouts, and its terminal is presented with multiple metal contacts. By inserting the interface card into the connector on the motherboard, the two devices can be electrically connected to achieve the purpose of expanding the functions of the motherboard.

Furthermore, the motherboard in the chassis inside the server or the industrial computer (IPC) usually has a PCI-E interface, and a hard drive, display card or other expansion interface card is installed through the PCI-E interface to expand the various functions of the server or the industrial computer. It must be easier and faster for users to maintain or replace various expansion interface cards inside the chassis. When a chassis is used for a long time, it is necessary to consider the stability of the entire system, the convenience of maintenance and replacement, and the convenience of user operation, so as to reduce downtime and manpower losses. However, some of the various interface cards currently used are fixed in the chassis by screw locking, and the screws are respectively passed through the through holes on the frame and then aligned and locked into the screw holes of the interface card. This screw locking method not only requires the use of a large number of screws, but also requires the removal and installation of multiple screws one by one before disassembly and installation, which results in a considerable amount of time spent on assembly and a significant increase in downtime for maintenance. If the chassis is filled with various interface cards, memory storage devices, power cables, flat cables and other components, it will be very inconvenient to insert tools to lock it, and it may even cause the screws to fall off and be lost during the locking process.

On the other hand, when the interface card is installed in the slot of the motherboard and the locking screws are removed, an unlocked state is formed, it is often tilted and bounced up by the reset force of the elastic terminals or auxiliary elastic mechanism in the slot, and the multiple metal contacts on the bottom side of the interface card often form a tilted pin misconnection problem with the elastic terminals in the slot. This may cause a short circuit or burnout of the interface card or the motherboard. Therefore, how to prevent the interface card from being ejected with excessive force when unlocked and causing pin misconnection between the slots has become an issue that the industry is eager to solve.

### SUMMARY OF THE INVENTION

Therefore, in view of the above problems and deficiencies, the inventor collected relevant information and, after multiple evaluations and considerations, designed the invention of this fixing device for stepless buffer unlocking.

The main object of the present invention is to provide a fixing device for stepless buffer unlocking, which comprises a base, a slide and a support. The base comprises a base body, a receiving chamber formed in the base body, a through hole disposed in the middle of the bottom side of the base body, and a block disposed at the rear end of the base body. The slide is disposed in the receiving chamber of the base. The slide comprises a substrate, a gradient groove located on the substrate corresponding to the position of the through hole of the base, a relatively narrower locking side formed at one end of the gradient groove, a relatively wider unlocking side formed at an opposite end of the gradient groove, an abutment block protruding downward from one side of a bottom of the substrate, a stop surface formed on an opposite side of the bottom of the substrate for contacting the block of the base at an inclined angle, and an elastic member placed on the substrate and supported between a front of the abutment block and a front end of the base body. The support comprises a positioning plate fixed in a plate holder of a preset machine box, a positioning rod protruding upward from the positioning plate and extending into the through hole of the base and the gradient groove of the slide, and an annular stop surface formed between the positioning plate and the positioning rod.

Through the above, the fully unlocked state is formed when the positioning rod is located at the unlocking side of the gradient groove and the elastic member is in a compressed state, and the stop surface of the slide contacts the block of the base. When the support moves upward and the annular stop surface pushes the slide to rotate upward with the abutment block as a fulcrum, the stop surface of the slide is separated from the block of the base and changes from a tilted state to a horizontal state. When the slide is pushed by the elastic member in the extended state and the positioning rod is contacted between the unlocking side and locking side of the gradient groove, a semi-unlocked state with interference resistance is formed. When the slide is pushed by the elastic member in the extended state and the positioning rod is inserted into the locking side of the gradient groove, a fully locked state is formed. When the user applies force to the base and the slide fixed to the preset interface card and switches from the fully locked state to the semi-unlocked state, the support fixed to the preset machine box and the preset interface card can form resistance when they are disengaged, so that the pop-up force of the preset interface card is reduced and it can be moved upward vertically from the preset slot in a stepwise manner to a predetermined distance. After applying force to the base and the slide again to switch from the semi-unlocked state to the fully unlocked state, the preset interface card can be removed vertically from the preset slot to avoid the problem of misconnection of the multiple metal contacts on the bottom side of the interface card with the elastic terminals in the slot.

Another object of the present invention is that both sides of the top of the base are provided with supporting spring plates which are pressed downward against the surface of the substrate of the slide; both sides of the top of the base are provided with baffles for supporting against the surface of the substrate of the slide when the substrate is in a semi-unlocked state or a fully locked state; the base has at least one engaging portion protruding downward from the bottom surface of the base body and engaged and fixed in a plate of a preset interface card.

Still another object of the present invention is that a positioning rod is convexly provided on the inner wall surface of the front end of the base body of the base, and a receiving groove is concavely provided at the front of the substrate of the slide extending to the abutment block corresponding to the positioning rod, and the positioning rod and the receiving groove are used to fix the two ends of the elastic member; the abutment block toward the stop surface is recessed to form an arc-shaped groove for accommodating the side edge of the positioning plate of the support.

Still another object of the present invention is that the slide is formed with an operating portion bent upward above the substrate corresponding to the stop surface.

Still another object of the present invention is that the positioning plate of the support is composed of a cylinder that is larger at the bottom and smaller at the top, and the annular stop surface is formed on the surface of the upper side of the cylinder, and the positioning rod is formed on the top side of the upper side of the cylinder, and the positioning rod is a rod body with a tapered structure that is wider at the top and narrower at the bottom.

### BRIEF DESCRIPTION OF THE DRAWINGS

FIG. 1 is a three-dimensional external view of the first embodiment of the fixing device of the present invention.

FIG. 2 is a three-dimensional exploded view of the first embodiment of the fixing device of the present invention.

FIG. 3 is a three-dimensional exploded view of the first embodiment of the fixing device of the present invention from another viewing angle.

FIG. 4 is a side view of the first embodiment of the fixing device of the present invention in a fully unlocked state.

FIG. 5 is a three-dimensional view of the first embodiment of the fixing device of the present invention in a fully locked state.

FIG. 6 is a side cross-sectional view of the base and the slide at sections A-A, B-B, and C-C of the first embodiment of the fixing device of the present invention.

FIG. 7 is a three-dimensional external view of the second embodiment of the fixing device of the present invention.

FIG. 8 is a three-dimensional exploded view of the second embodiment of the fixing device of the present invention.

FIG. 9 is a three-dimensional exploded view of the second embodiment of the fixing device of the present invention from another viewing angle.

FIG. 10 is a side view of the second embodiment of the fixing device of the present invention in a fully unlocked state.

FIG. 11 is a three-dimensional view of the second embodiment of the fixing device of the present invention in a fully locked state.

### DETAILED DESCRIPTION OF THE PREFERRED EMBODIMENT

In order to achieve the above-mentioned objects and effect, the technical means and structure adopted by the present invention are described in detail with reference to the preferred embodiments of the present invention, and its features and functions are as follows for a complete understanding.

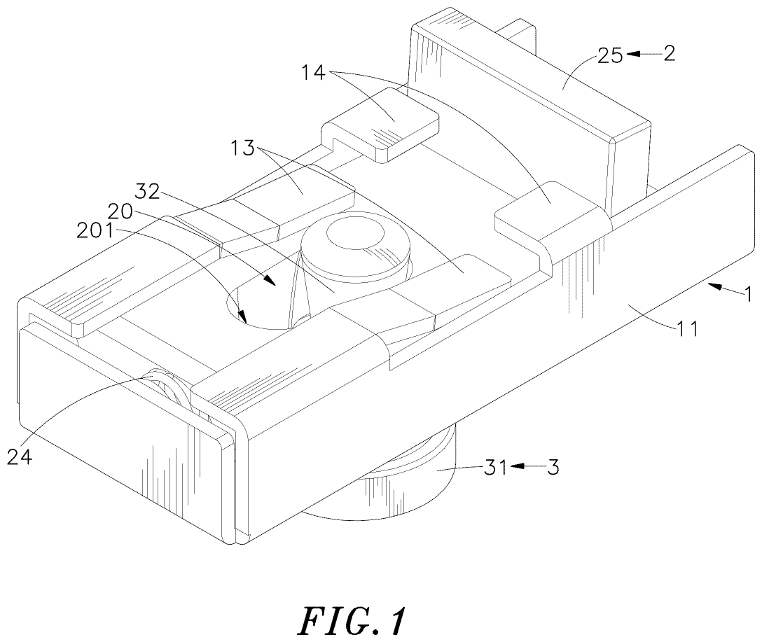

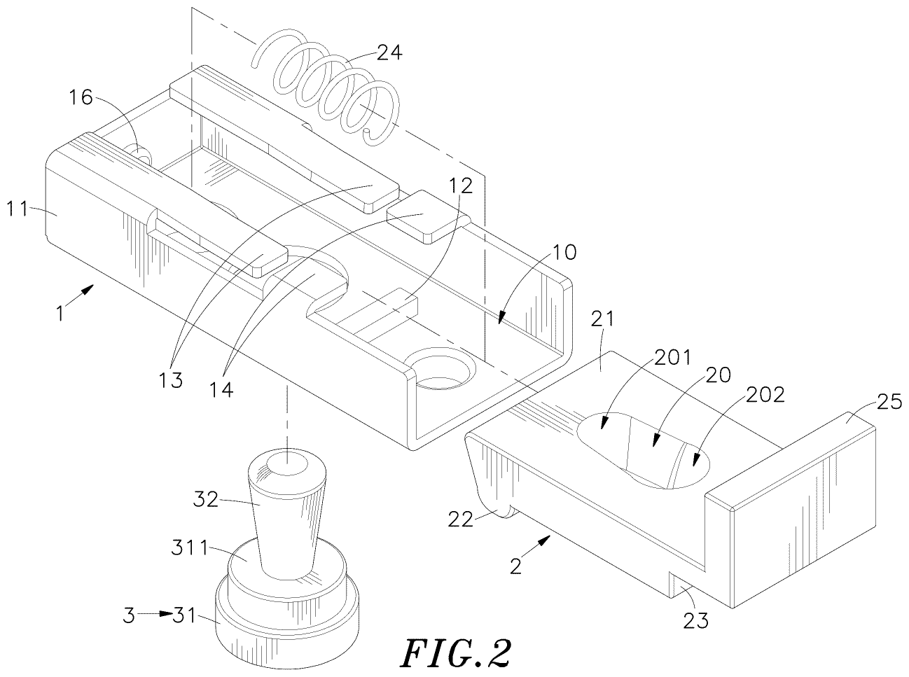

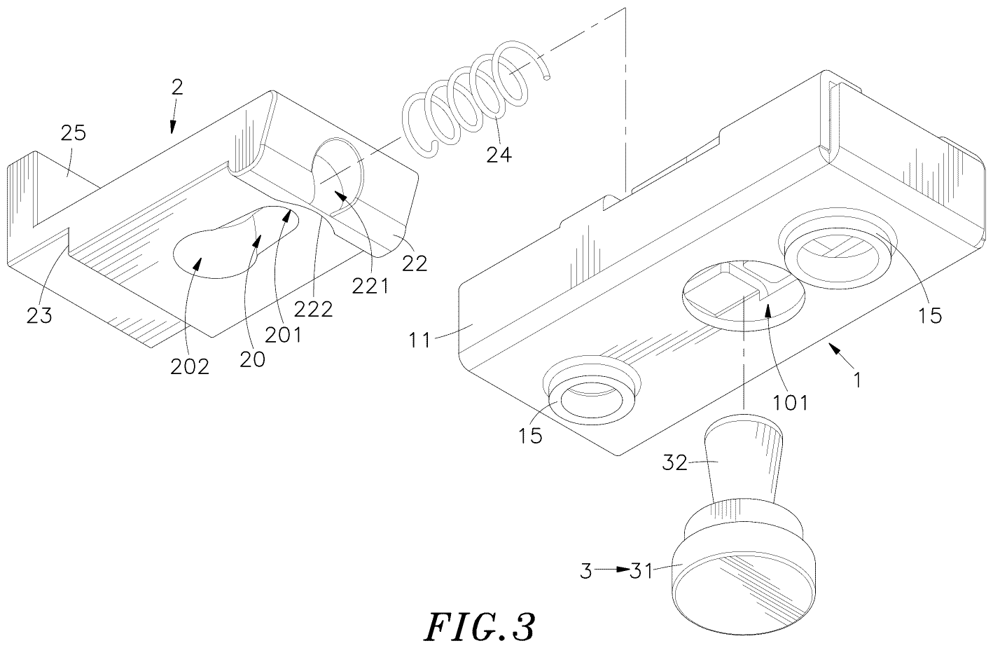

Please refer to FIGS. 1 to 5, which are respectively a three-dimensional external view, a three-dimensional exploded view, a three-dimensional exploded view from another viewing angle, a side view in a fully unlocked state, and a three-dimensional view in a fully locked state of the first embodiment of the fixing device of the present invention. As can be clearly seen from the figures, the fixing device of the present invention mainly comprises a base 1, a slide 2 and a support 3, and its main components and features are described in detail as follows:

The base 1 comprises a base body 11, a receiving chamber 10 formed in the base body 11, a through hole 101 disposed in the middle of the bottom side of the base body 11 and a block 12 disposed at the rear end of the base body 11.

The slide 2 is disposed in the receiving chamber 10 of the base 1. The slide 2 comprises a substrate 21, a gradient groove 20 located on the substrate 21 corresponding to the position of the through hole 101, a narrower locking side 201 formed at one end of the gradient groove 20, a wider unlocking side 202 formed at an opposite end of the gradient groove 20, an abutment block 22 protruding downward from one side of the bottom of the substrate 21, a stop surface 23 formed on an opposite side of the bottom of the substrate 21 for contacting the block 12 at an inclined angle. Furthermore, an elastic member 24 is placed on the substrate 21 and supported between the front of the abutment block 22 and the front end of the base body 11.

The support 3 comprises a positioning plate 31 fixed in a plate holder (not shown) of a preset machine box, a positioning rod 32 protruding upward from the positioning plate 31 and extending into the through hole 101 of the base 1 and the gradient groove 20 of the slide 2, and an annular stop surface 311 formed between the positioning plate 31 and the positioning rod 32. When the positioning rod 32 is located at the unlocking side 202 of the gradient groove 20 and the elastic member 24 is in a compressed state, and the stop surface 23 of the slide 2 contacts the block 12 of the base 1, a fully unlocked state is formed. When the support 3 moves upward and the annular stop surface 311 pushes the slide 2 to rotate upward with the abutment block 22 as a fulcrum and transform from a tilted state to a horizontal state, the stop surface 23 of the slide 2 is separated from the block 12 of the base 1. When the elastic member 24 in the extended state pushes the slide 2 and makes the positioning rod 32 contact between the unlocking side 202 and the locking side 201 of the gradient groove 20, a semi-unlocked state with interference resistance is formed. When the elastic member 24 in the extended state pushes the slide 2 and makes the positioning rod 32 lock into the locking side 201 of the gradient groove 20, a fully locked state is formed.

The two sides of the top of the base 1 are respectively provided with a supporting spring plate 13 which is supported downward on the surface of the substrate 21 of the slide 2. The top of the base 1 is provided with baffles 14 on both sides thereof for supporting the surface of the substrate 21 when the substrate 21 of the slide 2 is in the semi-unlocked state or the fully locked state. The base 1 further comprises at least one engaging portion 15 protruding downward from the bottom surface of the base body 11 and engaged and fixed in a plate (not shown) of a preset interface card.

The front inner wall surface of the base body 11 of the base 1 is convexly provided with a positioning rod 16, and the substrate 21 of the slide 2 is extended forward to the abutment block 22 and is concavely provided with a receiving groove 221 corresponding to the positioning rod 16. The positioning rod 16 and the receiving groove 221 are used to fix the two ends of the elastic member 24. The elastic member 24 is formed of a spring; and the abutment block 22 toward the stop surface 23 is recessed to form an arc-shaped groove 222 for accommodating the side edge of the positioning plate 31 of the support 3.

The slide 2 is formed with an operating portion 25 bent upward above the substrate 21 corresponding to the stop surface 23.

The positioning plate 31 of the support 3 is formed of a cylinder with a larger bottom and a smaller top, and the annular stop surface 311 is formed on the surface of the upper side of the cylinder, and the positioning rod 32 is formed on the top of the upper side of the cylinder. The positioning rod 32 is a rod body having a tapered structure with a wider top and a narrower bottom. The positioning rod 32 can cooperate with the contact position in the gradient groove 20 to form the height changes of the slide 2.

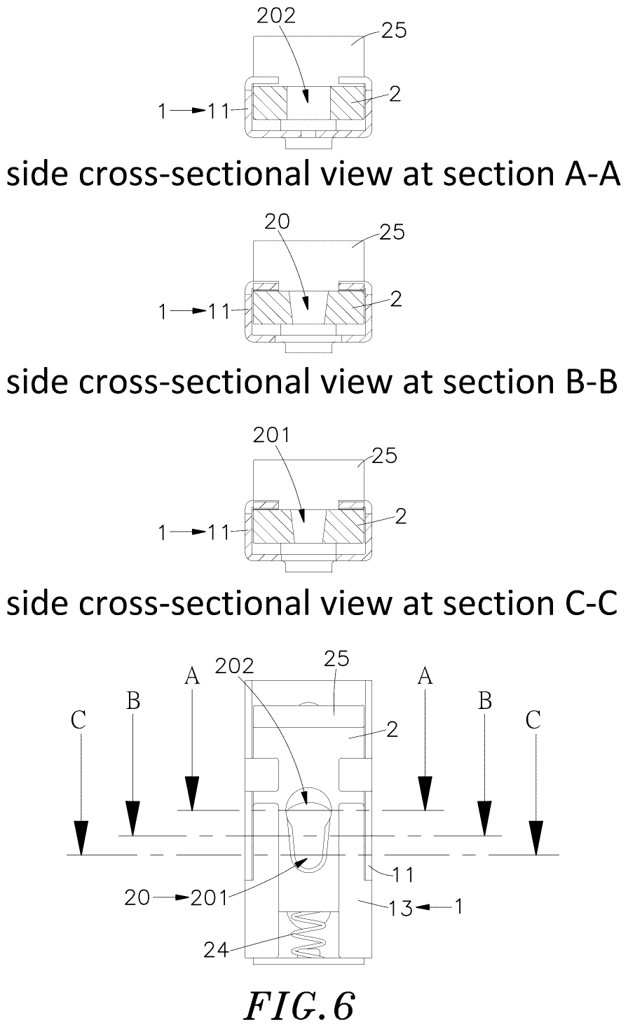

Please refer to FIG. 6, which is a side cross-sectional view of the base and the slide at sections A-A, B-B, and C-C of the first embodiment of the fixing device of the present invention. From the bottom top view, it can be seen that the gradient groove 20 of the slide 2 is close to a teardrop-shaped configuration, wherein the A-A section shows the fully unlocked position of the gradient groove 20; the B-B section shows the semi-unlocked position of the gradient groove 20; the C-C section shows the fully locked position of the gradient groove 20. However, no matter in the fully unlocked position, the semi-unlocked position or the fully locked position, it can be seen that the gradient groove 20 is in a tapered structure that is wide at the top and narrow at the bottom. When the slide 2 is fully unlocked, semi-unlocked or fully locked, the gradient groove 20 in the tapered structure can be fully and tightly attached to the tapered positioning rod 32 of the support 3 to form interference resistance and slow down the moving speed of the slide 2. When the gradient groove 20 is tightly attached to the positioning rod 32, it will cause the slide 2 to rise and fall when it moves. When the positioning rod 32 is located at the unlocking side 202 of the gradient groove 20, a larger hole diameter of the unlocking side 202 fits exactly with the thicker area of the upper part of the positioning rod 32. On the contrary, when the positioning rod 32 is located at the locking side 201 of the gradient groove 20, a smaller hole diameter of the locking side 201 fits the thinner area of the lower part of the positioning rod 32. When the positioning rod 32 is located between the locking side 201 and the unlocking side 202 of the gradient groove 20, the gradient groove 20 will be tightly attached to the middle area of the positioning rod 32. The aforementioned operating principle is also applicable to the second embodiment of the fixing device described below.

When assembling the first embodiment of the fixing device of the present invention, first insert one end of the elastic member 24 into the receiving groove 221 of the slide 2 to form a positioning, then attached the other end of the elastic member 24 positioned in the slide 2 onto the positioning rod 16 of the base 1 made of metal material, and then place the slide 2 downward in the receiving chamber 10 and make the stop surface 23 engage with the block 12. Then, the two supporting spring plates 13 and the two baffles 14 on the two sides of the base 1 are bent inward and formed on the top of the slide 2 by using a preset punching jig. The assembly of the base 1 and the slide 2 is completed by the above steps.

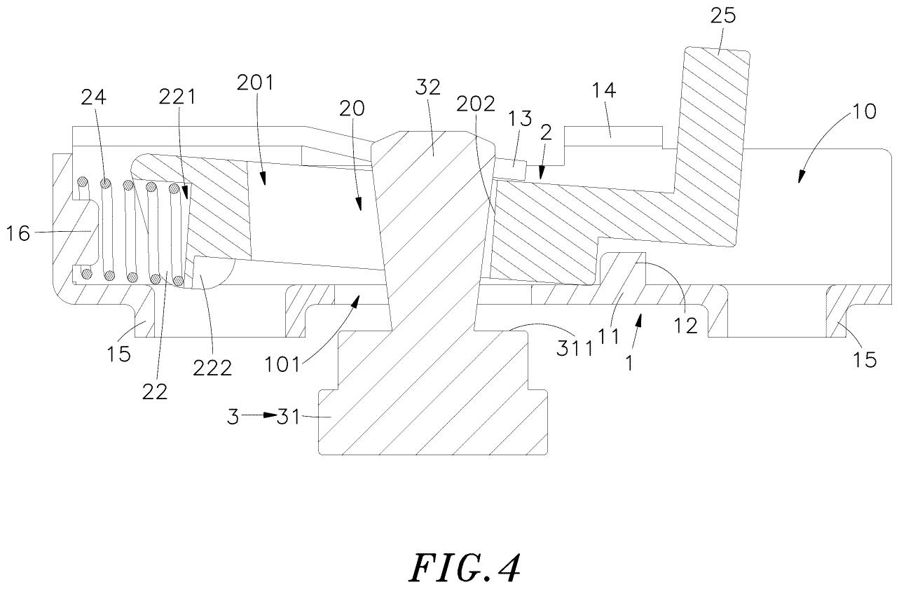

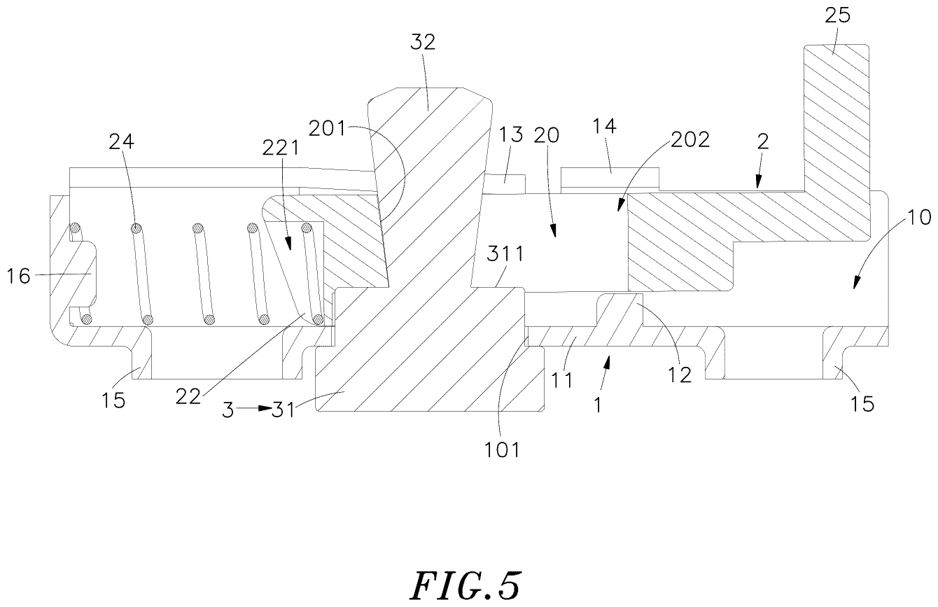

Please refer to FIGS. 4 and 5. In actual operation of the first embodiment of the fixing device, the base 1 and slide 2 of the fixing device are first placed in a preset plate (not shown) through the engaging portion 15 at the bottom, and the plate can be a metal plate located on the side of a preset interface card. The support 3 is fixed to a plate holder (not shown) through the positioning plate 31. The plate holder can be a side plate holder for a fixing device on a metal plate on the side of the preset interface card in a preset machine box (not shown). To fix the plate and the plate holder, the base 1, the slide 2 and the plate need to be pressed down, so that the positioning rod 32 of the support 3 on the plate holder extends into the through hole 101 of the base 1, the receiving chamber 10 and the unlocking side 202 of the gradient groove 20, and the top of the positioning rod 32 is exposed above the slide 2 and the elastic member 24 is in a compressed state. When the stop surface 23 of the slide 2 is inclined to contact the block 12 of the base 1, a fully unlocked state is formed. When the base 1, the slide 2 and the plate are pressed downward, the support 3 moves upward relatively and the annular stop surface 311 pushes the slide 2 to rotate upward with the abutment block 22 as a fulcrum, so that the stop surface 23 of the slide 2 is separated from the block 12 of the base 1 and changes from the tilted state to the horizontal state, and the elastic member 24 in the extended state pushes the slide 2 at one time and makes the positioning rod 32 engage in the locking side 201 of the gradient groove 20 to form a fully locked state. The fixing state of the plate and the plate holder is formed by the above steps.

To disassemble the plate and the plate holder in a stepwise manner, apply force to the operating portion 25 of the slide 2 to push it toward the positioning rod 16 of the base 1. When the positioning rod 32 contacts the unlocking side 202 and the locking side 201 of the gradient groove 20 to form a semi-unlocked state with interference resistance, the support 3 fixed to the plate holder (set in the preset machine box) and the base 1 and the slide 2 fixed to the plate (set in the preset interface card) can form resistance when they are separated. After the pop-up force of the preset interface card is reduced, it can be moved upward vertically from the preset slot (not shown) in a stepwise manner to a predetermined distance. Apply force to push the operating portion 25 of the slide 2 again so that the positioning rod 32 is located in the unlocking side 202 of the gradient groove 20 to form a fully unlocked state, and the preset interface card can be removed and pulled out from the preset slot in a vertical direction. The stepwise disassembly of the plate and the plate holder is completed by the above steps.

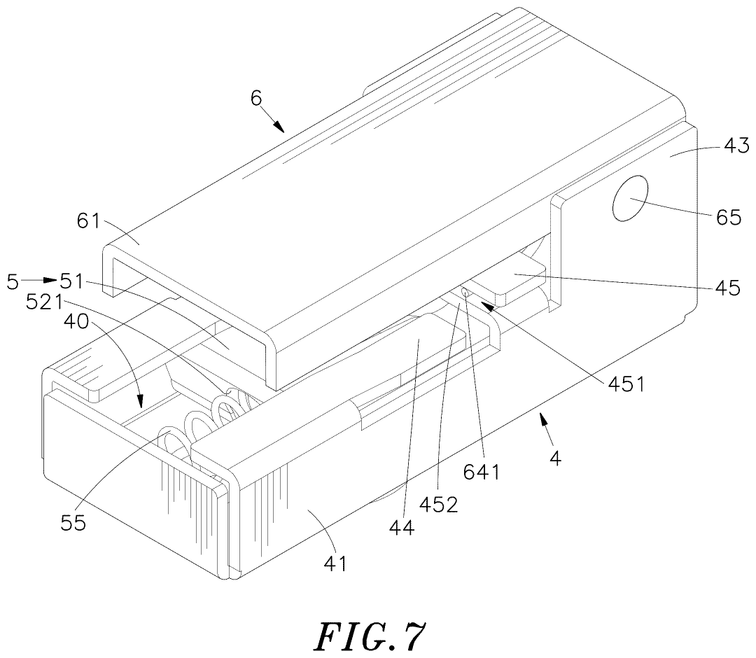

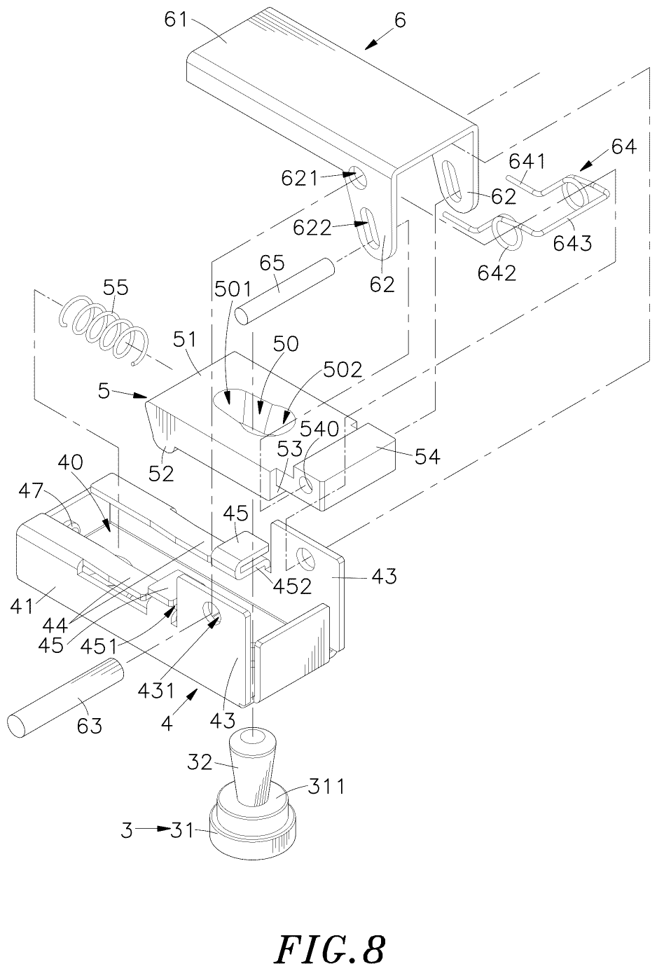

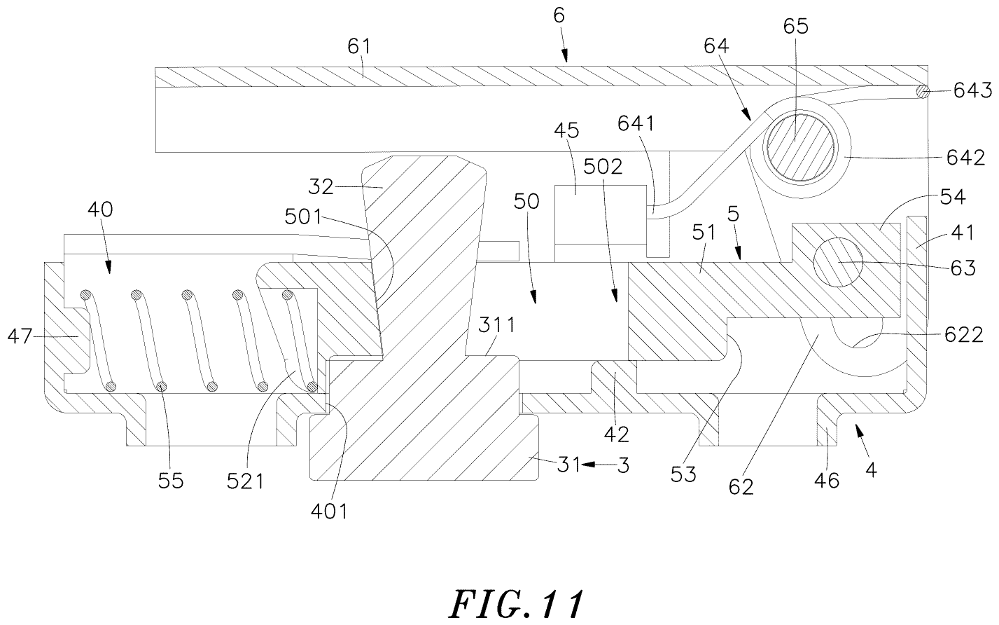

Please refer to FIGS. 7 to 11, which are respectively a three-dimensional external view of the second embodiment of the fixing device, a three-dimensional exploded view, a three-dimensional exploded view from another viewing angle, a side view in a fully unlocked state, and a three-dimensional view in a fully locked state. The difference between the second embodiment and the above-mentioned first embodiment is that a lever 6 is pivotally connected between a base 4 and a slide 5. The stepwise disassembly of the plate and the plate holder by pushing the slide 5 through the lever 6 is simpler and more convenient. The components of the second embodiment and the first embodiment have many similarities. The main components and features are described in detail as follows:

The base 4 comprises a base body 41, a receiving chamber 40 formed in the base body 41, a through hole 401 provided in the middle of the bottom side of the base body 41, a block 42 provided at the rear end of the base body 41, two connecting plates 43 respectively formed at the rear ends of both sides of the base body 41. Each of the two connecting plates 43 have an axial groove 431.

The slide 5 is disposed in the receiving chamber 40 of the base 4. The slide 5 comprises a substrate 51, a gradient groove 50 located on the substrate 51 corresponding to the position of the through hole 401, a narrower locking side 501 formed at one end of the gradient groove 50, a wider unlocking side 502 formed at an opposite end of the gradient groove 50, an abutment block 52 protruding downward from one side of the bottom of the substrate 51, a stop surface 53 formed on an opposite side of the bottom of the substrate 51 for contacting the block 42 at an inclined angle. Furthermore, the stop surface 53 extends rearward to form an attachment portion 54, and the attachment portion 54 has a through passage 540 in a through-shaped manner, and the substrate 51 is provided with an elastic member 55 between the front of the abutment block 52 and the front end of the base body 41.

The lever 6 comprises a plate-shaped handle 61, two turning side plates 62 respectively extending downward from the rear ends of both sides of the handle 61, a hollow through hole 621 and a sliding groove 622 formed on each of the two turning side plates 62, a pivot 63 positioning in the two axial grooves 431 of the base 4 and the two hollow through holes 621, an elastic element 64 provided on the pivot 63 and positioned between the two axial grooves 431 and the two hollow through holes 621, and a sliding rod 65 positioning in the two sliding grooves 622 and the through passage 540 of the slide 5, so that the lever 6 is pivoted on the base 4 and can drive the slide 5 to generate horizontal linear movement when rotating.

The support 3 comprises a positioning plate 31 fixed in a plate holder (not shown) of a preset machine box, a positioning rod 32 protruding upward from the positioning plate 31 and extending into the through hole 401 of the base 4 and the gradient groove 50 of the slide 5, and an annular stop surface 311 formed between the positioning plate 31 and the positioning rod 32. When the positioning rod 32 is located at the unlocking side 502 of the gradient groove 50 and the elastic member 55 is in a compressed state, and the stop surface 53 of the slide 5 contacts the block 42 of the base 4, and at the same time, the lever 6 is pivoted on the base 4 at an inclined angle, a fully unlocked state is formed. When the support 3 moves upward and the annular stop surface 311 pushes the slide 5 to rotate upward with the abutment block 52 as a fulcrum and transform from a tilted state to a horizontal state, the stop surface 53 of the slide 5 is separated from the block 42 of the base 4. When the slide 5 is pushed by the lever 6 and the elastic member 55 in the extended state, and the positioning rod 32 contacts between the unlocking side 502 and the locking side 501 of the gradient groove 50, and at the same time, the lever 6 is pivoted on the base 4 at a relatively small inclined angle, a semi-unlocked state with interference resistance is formed. When the slide 5 is pushed by the lever 6 and the elastic member 55 in the extended state, and the positioning rod 32 is locked into the locking side 501 of the gradient groove 50, and at the same time, the lever 6 is pivoted on the base 4 at a parallel angle, a fully locked state is formed.

Both sides of the top of the base 4 are provided with supporting spring plates 44 which are pressed downward against the surface of the substrate 51 of the slide 5. The top of the base 4 is provided with a clamping spring sheet 45 on each of both sides thereof, and the two clamping spring sheets 45 are respectively formed with a slot 451 for receiving two fixing end portions 641 of the elastic element 64. The elastic element 64 is formed of a torsion spring and comprises two annular portions 642 sleeved on the pivot 63, and a supporting section 643 connected between the two annular portions 642 opposite to the fixing end portions 641 and contacting the inner side of the lever 6. A stopper 452 is formed on the bottom side of each clamping spring sheet 45 for supporting the surface of the substrate 51 when the substrate 51 of the slide 5 is in the semi-unlocked state or the fully locked state. The base 4 further has at least one engaging portion 46 protruding downward from the bottom surface of the base body 41 and engaged and fixed in a plate (not shown) of a preset interface card.

The front inner wall surface of the base body 41 of the base 4 is convexly provided with a positioning rod 47, and the substrate 51 of the slide 5 extends forward to the abutment block 52 and is recessed to form a receiving groove 521 corresponding to the positioning rod 47. The positioning rod 47 and the receiving groove 521 are used to fix the two ends of the elastic member 55. The abutment block 52 toward the stop surface 53 is recessed to form an arc-shaped groove 522 for accommodating the side edge of the positioning plate 31 of the support 3.

The hollow through holes 621 of the lever 6 are located above the two sliding grooves 622, and the hollow through holes 621 are round holes and the sliding grooves 622 are longitudinal elliptical grooves. When the lever 6 is on the base 4 and is in a fully unlocked state at an inclined angle, the sliding rod 65 slides to the bottom ends of the sliding grooves 622. When the lever 6 is pivoted on the base 4 at a parallel angle and is in a fully locked state, the sliding rod 65 slides to the uppermost ends of the sliding grooves 622.

The positioning plate 31 of the support 3 is formed of a cylinder with a larger bottom and a smaller top, and the annular stop surface 311 is formed on the surface of the upper side of the cylinder, and the positioning rod 32 is formed on the top of the upper side of the cylinder. The positioning rod 32 is a rod body having a tapered structure with a wider top and a narrower bottom. The positioning rod 32 can cooperate with the contact position in the gradient groove 50 to form the height changes of the slide 5.

Furthermore, the assembly process of the second embodiment of the fixing device of the present invention is very similar to the above-mentioned assembly process of the first embodiment of the fixing device, so it will not be repeated again. The assembly process of the second embodiment of the fixing device has many possibilities in selecting the elastic member 55 and the elastic element 64. Depending on the interference resistance or elastic coefficient of the positioning rod 32 contacting the gradient groove 50, one or the other can be selected for use, or both the elastic member 55 and the elastic element 64 can be used. Such elastic changes in the assembly should be included in the protection scope of the present invention.

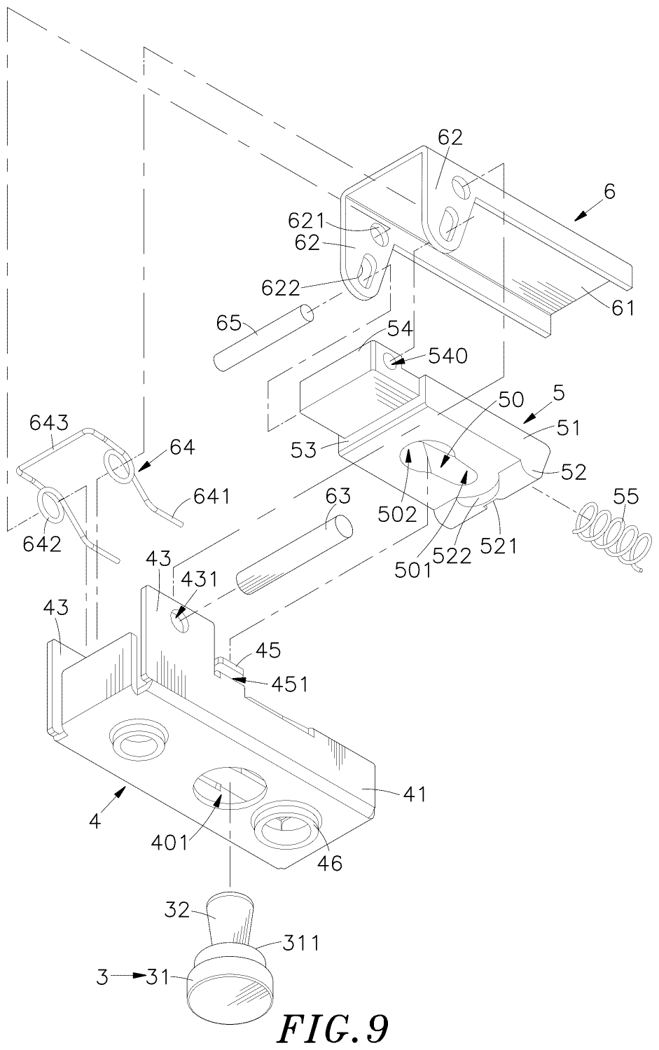

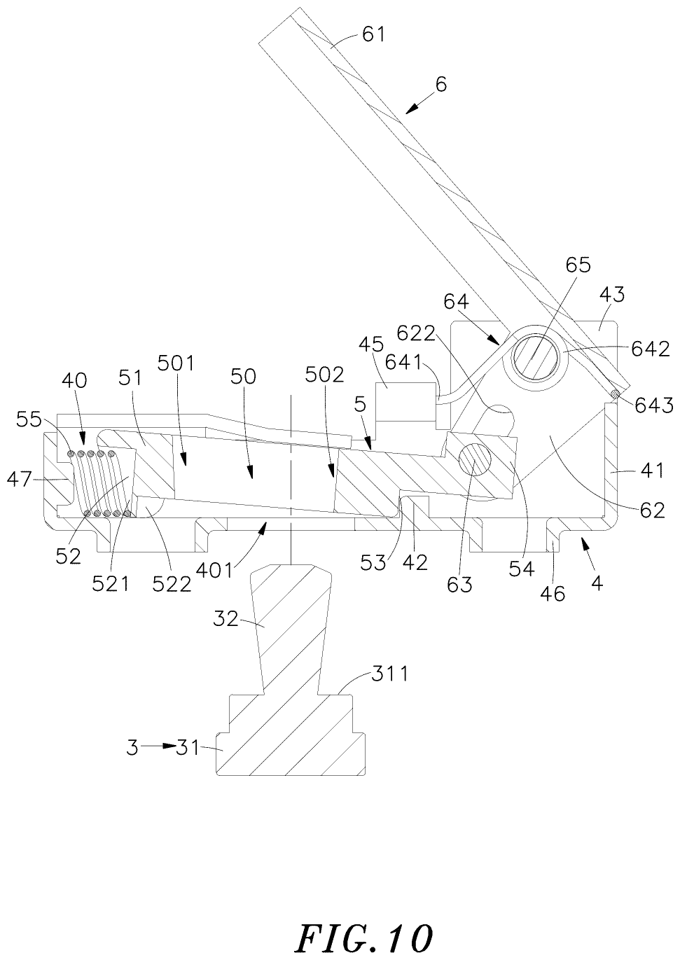

Please refer to FIGS. 9 and 10. In actual operation of the second embodiment of the fixing device, the base 4 and slide 5 of the fixing device are first placed in a preset plate (not shown) through the engaging portion 46 at the bottom, and the plate can be a metal plate located on the side of a preset interface card. The support 3 is fixed to a plate holder (not shown) through the positioning plate 31. The plate holder can be a side plate holder for a fixing device on a metal plate on the side of a preset interface card in a preset machine box (not shown). To fix the plate and the plate holder, the base 4, the slide 5 and the plate need to be pressed down so that the positioning rod 32 of the support 3 on the plate holder extends into the through hole 401 of the base 4, the receiving chamber 40 and the unlocking side 502 of the gradient groove 50, and the top of the positioning rod 32 is exposed above the slide 5 and the elastic member 55 is in a compressed state. At the same time, the lever 6 is pivoted on the base 4 at an inclined angle, and when the stop surface 53 of the slide 5 is inclined to contact the block 42 of the base 4, a fully unlocked state is formed. During the process of applying force to press the base 4, the slide 5 and the plate downward, the support 3 moves upward relatively and the annular stop surface 311 pushes the slide 5 to rotate upward with the abutment block 52 as a fulcrum, so that the stop surface 53 of the slide 5 separates from the block 42 of the base 4 and transforms from a tilted state to a horizontal state. The elastic member 55 in the extended state pushes the slide 5 at one time and causes the positioning rod 32 to be engaged in the locking side 501 of the gradient groove 50 to form a fully locked state. At the same time, the lever 6 is naturally pivoted on the base 4 at a parallel angle and the elastic element 64 is in an over-twisted state. Through the above operations, the plate and the plate holder are fixed.

To disassemble the plate and the plate holder in a stepwise manner, apply force to the plate-shaped handle 61 of the lever 6 at a relatively small angle and obtain the restoring force of the elastic element 64 to easily pull up. The lever 6 pushes the slide 5 through the sliding rod 65 and moves the positioning rod 32 toward the unlocking side 502 of the gradient groove 50. When the positioning rod 32 contacts the unlocking side 502 and the locking side 501 of the gradient groove 50 to form a semi-unlocked state with interference resistance, the support 3 fixed to the plate holder (set in the preset machine box) and the base 4 and the slide 5 fixed to the plate (set in the preset interface card) can form resistance when they are separated. After the pop-up force of the preset interface card is reduced, it can be moved upward vertically from the preset slot (not shown) in a stepwise manner to a predetermined distance. Apply force to the plate-shaped handle 61 of the lever 6 again and pull it upward at the maximum angle so that the positioning rod 32 is located in the unlocking side 502 of the gradient groove 50 to form a fully unlocked state, and then the preset interface card can be removed and pulled out from the preset slot in a vertical direction. Through the above operations, the stepwise disassembly of the plate and the plate holder is completed.

The main features of the present invention are: the fixing device is in a fully unlocked state when the positioning rod 32 is located at the unlocking side (202, 502) of the gradient groove (20, 50) and the elastic member (24, 55) is in a compressed state, and the stop surface (23, 53) of the slide (2, 5) contacts the block (12, 42) of the base (1, 4); when the support 3 moves upward, and the annular stop surface 311 pushes the slide (2, 5) to rotate upward with the abutment block (22, 52) as a fulcrum, the stop surface (23, 53) of the slide (2, 5) is separated from the block (12, 42) of the base (1, 4); when the slide (2, 5) is pushed by the elastic member (24, 55) in the extended state, and the positioning rod 32 is contacted between the unlocking side (202, 502) and the locking side (201, 501) of the gradient groove (20, 50), a semi-unlocked state with interference resistance is formed; when the slide (2, 5) is pushed by the elastic member (24, 55) in the extended state, and the positioning rod 32 is engaged with the locking side (201, 501) of the gradient groove (20, 50), a fully locked state is formed. When the user applies force to the base (1, 4) and the slide (2, 5) fixed to the preset interface card and switches from a fully locked state to a semi-unlocked state, the support 3 fixed to the preset machine box and the preset interface card can form resistance when they are separated, so that the pop-up force of the preset interface card is reduced and it can be moved upward vertically from the preset slot in a stepwise manner to a predetermined distance, and applying force to the base (1, 4) and the slide (2, 5) again to switch from the semi-unlocked state to the fully unlocked state, the preset interface card can be removed vertically from the preset slot to avoid the problem of misalignment of the multiple metal contacts on the bottom side of the interface card and the elastic terminals in the slot.

The above are only preferred embodiments of the present invention, and do not limit the patent scope of the present invention. Therefore, all simple modifications and equivalent structural changes made by using the contents of the description and drawings of the present invention should be included in the patent scope of the present invention and should be declared.

In summary, the fixing device for stepless buffer unlocking of the present invention can achieve its effect and purpose when used. Therefore, this invention is truly an invention with excellent practicality. In order to meet the application requirements for invention patents, we have filed an application in accordance with the law. We hope that the review committee will approve this case as soon as possible to protect the inventor's hard work in research and development. If the review committee has any questions, please feel free to write to us for instructions. The inventor will do his best to cooperate and we will be very grateful.

What the invention claimed is:

1. A fixing device for stepless buffer unlocking, comprising
a base comprising a base body, a receiving chamber formed in said base body, a through hole disposed in a middle of a bottom side of said base body and a block disposed at a rear end of said base body;
a slide disposed in said receiving chamber of said base, said slide comprising a substrate, a gradient groove located on said substrate corresponding to the position of said through hole of said base, a relatively narrower locking side formed at one end of said gradient groove, a relatively wider unlocking side formed at an opposite end of said gradient groove, an abutment block protruding downward from one side of a bottom of said substrate, a stop surface formed on an opposite side of the bottom of said substrate for contacting said block of said base at an inclined angle, and an elastic member placed on said substrate and supported between a front of said abutment block and a front end of said base body; and
a support comprising a positioning plate fixed in a plate holder of a preset machine box, a positioning rod protruding upward from said positioning plate and extending into said through hole of said base and said gradient groove of said slide and an annular stop surface formed between said positioning plate and said positioning rod; and
wherein when said positioning rod is located at said unlocking side of said gradient groove and said elastic member is in a compressed state, and said stop surface of said slide contacts said block of said base, a fully unlocked state is formed; when said support moves upward and said annular stop surface pushes said slide to rotate upward with said abutment block as a fulcrum, said stop surface of said slide is separated from said block of said base; when said elastic member in an extended state pushes said slide and makes said positioning rod contact between said unlocking side and said locking side of said gradient groove, a semi-unlocked state with interference resistance is formed; when said elastic member in the extended state pushes said slide and makes said positioning rod lock into said locking side of said gradient groove, a fully locked state is formed.

2. The fixing device for stepless buffer unlocking as claimed in claim 1, wherein said base further comprises two supporting spring plates respectively located at two opposite sides of a top thereof and pressed downward against a surface of said substrate of said slide.

3. The fixing device for stepless buffer unlocking as claimed in claim 1, wherein said base further comprises two baffles respectively located at two opposite sides of a top thereof for abutting against a surface of said substrate when said substrate is in the semi-unlocked state or the fully locked state.

4. The fixing device for stepless buffer unlocking as claimed in claim 1, wherein said base further comprises at least one engaging portion protruding downward from a bottom surface of said base body and fixedly engaged in a plate of a preset interface card.

5. The fixing device for stepless buffer unlocking as claimed in claim 1, wherein said base further comprises a positioning rod located at a front inner wall surface of said base body, said substrate of said slide extends forward to said abutment block and is concavely provided with a receiving groove corresponding to said positioning rod of said base, and said elastic member has two opposite ends respectively fastened to said positioning rod and said receiving groove; said abutment block toward said stop surface is recessed to form an arc-shaped groove for accommodating a side edge of said positioning plate of said support.

6. The fixing device for stepless buffer unlocking as claimed in claim 1, wherein said slide is formed with an operating portion bent upward above said substrate corresponding to said stop surface.

7. The fixing device for stepless buffer unlocking as claimed in claim 1, wherein said positioning plate of said support is formed of a cylinder with a larger bottom and a smaller top, and said annular stop surface is formed on a surface of an upper side of the cylinder, and said positioning rod is formed on a top of the upper side of the cylinder; said positioning rod is a rod body having a tapered structure with a wider top and a narrower bottom, said positioning rod being capable of cooperating with the contact position in said gradient groove to form height changes of said slide.

8. A fixing device for stepless buffer unlocking, comprising
a base comprising a base body, a receiving chamber formed in said base body, a through hole disposed in a middle of a bottom side of said base body, a block disposed at a rear end of said base body, two connecting plates respectively formed at respective rear ends of two opposite sides of said base body, and an axial groove located on each of said connecting plates;
a slide disposed in said receiving chamber of said base, said slide comprising a substrate, a gradient groove located on said substrate corresponding to the position of said through hole of said base, a relatively narrower locking side formed at one end of said gradient groove, a relatively wider unlocking side formed at an opposite end of said gradient groove, an abutment block protruding downward from one side of a bottom of said substrate, a stop surface formed on an opposite side of the bottom of said substrate for contacting said block of said base at an inclined angle, an attachment portion extending rearward from said stop surface, a through passage formed on said attachment portion in a through-shaped manner and an elastic member placed on said substrate and supported between a front of said abutment block and a front end of said base body;
a lever comprising a plate-shaped handle, two turning side plates respectively extending downward from respective rear ends of two opposite sides of said handle, a hollow through hole and a sliding groove formed on each of said two turning side plates, a pivot positioning in two said axial grooves of said base and two said hollow through holes, an elastic element provided on said pivot and positioned between two said axial grooves and two said hollow through holes, and a sliding rod positioning in two said sliding grooves and said through passage of said slide, so that said lever is pivoted on said base and is capable of driving said slide to generate horizontal linear movement when rotating; and
a support comprising a positioning plate fixed in a plate holder of a preset machine box, a positioning rod protruding upward from said positioning plate and extending into said through hole of said base and said gradient groove of said slide, and an annular stop surface formed between said positioning plate and said positioning rod; and
wherein when said positioning rod is located at said unlocking side of said gradient groove and said elastic member is in a compressed state, and said stop surface of said slide contacts said block of said base, and at the same time, said lever is pivoted on said base at an inclined angle, a fully unlocked state is formed; when said support moves upward and said annular stop surface pushes said slide to rotate upward with said abutment block as a fulcrum, said stop surface of said slide is separated from said block of said base; when said slide is pushed by said lever and said elastic member in the extended state, and said positioning rod contacts between said unlocking side and said locking side of said gradient groove, and at the same time, said lever is pivoted on said base at a relatively small inclined angle, a semi-unlocked state with interference resistance is formed; when said slide is pushed by said lever and said elastic member in the extended state, and said positioning rod is locked into said locking side of said gradient groove, and at the same time, said lever is pivoted on said base at a parallel angle, a fully locked state is formed.

9. The fixing device for stepless buffer unlocking as claimed in claim 8, wherein said base further comprises two supporting spring plates respectively located at two opposite sides of a top thereof and pressed downward against a surface of said substrate of said slide.

10. The fixing device for stepless buffer unlocking as claimed in claim 8, wherein said base further comprises two clamping spring sheets respectively located at two opposite sides of a top thereof, two slots respectively located on said two clamping spring sheets for receiving each of fixing end portions of said elastic element, and a stopper formed on a bottom side of each of said two clamping spring sheets for supporting the surface of said substrate when said substrate of said slide is in the semi-unlocked state or the fully locked state; said elastic element comprises two annular portions sleeved on said pivot, and a supporting section connected between said two annular portions opposite to said fixing end portions and contacting an inner side of said lever.

11. The fixing device for stepless buffer unlocking as claimed in claim 8, wherein said base further comprises at least one engaging portion protruding downward from a bottom surface of said base body and fixedly engaged in a plate of a preset interface card.

12. The fixing device for stepless buffer unlocking as claimed in claim 8, wherein said base further comprises a positioning rod located at a front inner wall surface of said base body, said substrate of said slide extends forward to said abutment block and is concavely provided with a receiving groove corresponding to said positioning rod of said base, and said elastic member has two opposite ends respectively fastened to said positioning rod and said receiving groove; said abutment block toward said stop surface is recessed to form an arc-shaped groove for accommodating a side edge of said positioning plate of said support.

13. The fixing device for stepless buffer unlocking as claimed in claim 8, wherein said hollow through holes of said lever located above two said sliding grooves are round holes, and said sliding grooves are longitudinal elliptical grooves; when said lever is on said base and is in the fully unlocked state at a inclined angle, said sliding rod slides to each of bottom ends of said sliding grooves; when said lever is pivoted on said base at a parallel angle and is in a fully locked state, said sliding rod slides to each of uppermost ends of sliding grooves.

14. The fixing device for stepless buffer unlocking as claimed in claim 8, wherein said positioning plate of said support is formed of a cylinder with a larger bottom and a smaller top, and said annular stop surface is formed on a surface of an upper side of the cylinder, and said positioning rod is formed on a top of the upper side of the cylinder; said positioning rod is a rod body having a tapered structure with a wider top and a narrower bottom, said positioning rod being capable of cooperating with the contact position in said gradient groove to form height changes of said slide.
